(19) United States
(12) Patent Application Publication
(10) Pub. No.: US 2015/0179006 A1
(43) Pub. Date: Jun. 25, 2015

(54) ELECTRONIC LOCKER SYSTEM

(71) Applicant: AMERICAN LOCKER GROUP, INC., Coppell, TX (US)

(72) Inventors: DAVID VON ZURMUEHLEN, Coppell, TX (US); RANDAL LYNCH, Lewisville, TX (US)

(21) Appl. No.: 14/543,757

(22) Filed: Nov. 17, 2014

Related U.S. Application Data
(60) Provisional application No. 61/905,192, filed on Nov. 16, 2013.

(51) Int. Cl. G07C 9/00

(52) U.S. Cl. CPC G07C 9/00039

(57) ABSTRACT

An electronic locker system with increased user ergonomics, convenience, functionality, flexibility of configuration, and increased profitability for the owner/operator of the electronic locker system. The electronic locker system has a kiosk server that can be used to control a plurality of locker columns to form a large array of lockers.

### CROSS-REFERENCE TO RELATED APPLICATIONS

This application claims benefit of U.S. Provisional Application No. 61/905,192, filed Nov. 16, 2014, entitled ELECTRONIC LOCKER SYSTEM, the specification of which is incorporated by reference herein in its entirety.

### TECHNICAL FIELD

This invention relates to securable enclosures such as lockers or other temporary storage devices. More particularly, this invention relates to securable enclosures in electronic locker systems, expandable electronic locker systems and the operation and configuration of such electronic locker systems.

### BACKGROUND

Securable enclosures and locker systems have advanced from being coin-operated with mechanical key based locking mechanisms on each securable enclosure. Securable enclosure and related locker systems now incorporate electronics locking mechanisms and electronic kiosks that allow a user to select, rent, and pay for use of the securable enclosure. The kiosk can be integrated into the electronic locker array or be provided at a location that is separate, apart or disjointed from the array of securable rentable enclosures. At the kiosk, a user may rent a securable enclosure and make payment for the rental. The user may then obtain or enter a personal identification number (PIN) of a predetermined length designated for the rented securable enclosure within the locker system. Alternately, some existing locker systems use biometrics and/or radiofrequency identification (RFID) tokens or cards in place of PINS for unlocking a securable enclosure.

Various drawbacks and design problems exist in previous locker systems. For example, if a user is required to use a PIN of a system defined fixed length, it may be difficult for the user to remember the PIN upon returning to the locker system to open the securable enclosure because the kiosk provided PIN is not a number that is familiar to or easy for the user to remember. Alternatively, the user may lose a locker system provided RFID token, card or device.

In some situations, the user is required to go back to the kiosk each time the user wishes to revisit and open a rented locker causing potentially long waits in a line in front of the kiosk. Furthermore, if the PIN codes are all the same length of, for example, a 3 digit number, it may be relatively simple for someone to guess the PIN of a rented locker enabling the potential for theft.

Electronic locker systems are expensive, time consuming to install, configure, test and set up. At a later time when a change in the system is required, often shutting down and reprogramming the entire system is required thereby adding further expense and lost profits.

What is needed is an electronic locker system with increased user ergonomics, convenience, functionality, flexibility of configuration, and increased profitability for the owner/operator of the locker system.

### BRIEF DESCRIPTION OF THE DRAWINGS

Various objects and advantages of the various embodiments of the invention will become apparent and more readily appreciated from the following description of the exemplary embodiments, taken in conjunction with the accompanying drawings, of which:

FIG. 1 depicts a kiosk-based locker system in accordance with an embodiment;

FIG. 2 depicts another kiosk-based locker system in accordance with an embodiment;

FIG. 3 depicts another embodiment of a kiosk-based locker system wherein each securable enclosure does not comprise a keypad;

FIG. 4 is a block system diagram for an embodiment of a kiosk-based locker system wherein each securable enclosure has a keypad configured to enable the user to open a rented securable enclosure;

FIG. 5 is a block diagram of a keypad and block circuit in accordance with an embodiment of the invention;

FIG. 6 is an embodiment of the face of a keypad panel associated with a securable enclosure(s) along with an LED indicator meaning summary chart in accordance with an embodiment of the invention;

FIG. 7 provides an embodiment of the keypad face without an overlay such that presser sensitive switches and backlighting for the overlay are shown;

FIGS. 8A, 8B and 8C provide a kiosk user interface flowchart depicting a method associated with a graphic user interface that may be used when initiating a locker rental, for opening a securable enclosure with a locker system after the rental time has expired, or for when the user forgot his PIN or securable enclosure number;

FIGS. 9A through 9C provide functions of embodiments of a kiosk server, a PLC and keypad circuitry as well as the electronic data and interactions there between when a user opens a rented locker; and

FIG. 10 provides functions of the kiosk server, the PLC and the keypad circuitry as well as the electronic data interactions there between when an administrator ends a securable enclosure rental or places a securable enclosure back into service for rental.

### DETAILED DESCRIPTION

Various electronic locker systems and techniques are described herein that resolve a variety of different problems. The various electronic locker systems and methods described herein provide keyless locker systems, kiosk based locker systems, administrative solutions, ergonomic, configuration and functional solutions, which may be used alone or combined to provide a user-friendly and owner/operator friendly electronic locker system that is economically viable.

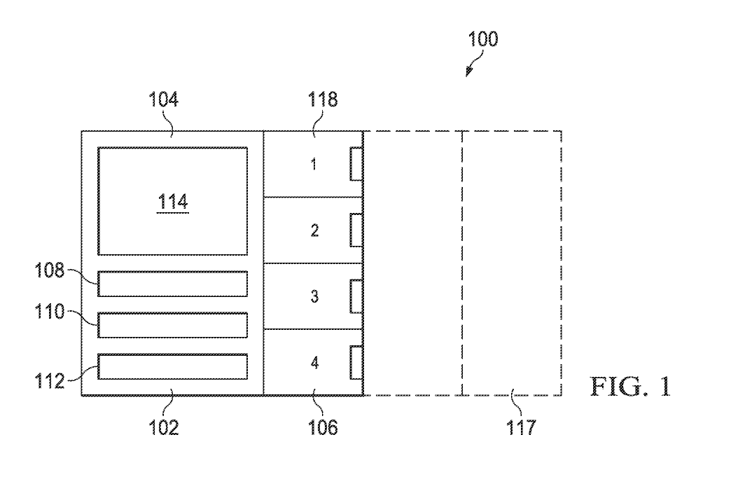

Referring to FIG. 1, an embodiment of a kiosk based locker system 100 is shown. The locker system 100 includes a kiosk column 102 wherein the kiosk column comprises a user interface 104. The user interface 104 allows a user to access the electronic locker system 100, rent and pay for a securable enclosure 106 within the locker system 100 and then at a later time, access and retrieve items that were stored in the securable enclosure 106. The payment can be made using a bill acceptor 108, credit card reader 110, or other electronic reader device adapted to receive units of exchange such as money. Upon payment, a receipt printer 112 may print both a receipt for the payment and an indication of the specific securable enclosure that is rented along with the PIN that must be used to unlock the securable enclosure 106 at a later time.

Inside the kiosk (not specifically shown here) may be a processor-based computer or server configured to interact with the user via the user interface 104, which may include a touchscreen, buttons or knobs, a graphic user interface (GUI) 114 displayed on the touchscreen, the bill acceptor 108, credit card reader 110 and receipt printer 112.

The individual securable enclosures 106 are configured in locker columns 116. Depending on their size, there can be one or a plurality of securable enclosures 106 in each locker column 116. A 1^{st} locker column 118 of securable enclosures abuts or is removably secured to a side panel of the kiosk column 102.

In this locker system embodiment 100, each individual securable enclosure 106 does not have a dedicated keypad to enter a PIN to open the each individual securable enclosure 106. Here, the user approaches the touchscreen 114 of the kiosk column 102 and follows the GUI instructions on the touchscreen 114. The kiosk instructions may require the user to indicate whether he wants to begin renting a securable enclosure or to open an already rented securable enclosure. If the user indicates that he wants to rent a locker 106, the GUI obtains information from the user as to how the user will pay for the rental of the securable enclosure. The user then indicates how payment will be made and, for example, makes payment either via the bill acceptor 108, the credit card reader 110 or other point of payment device. The kiosk system then assigns a particular locker number or securable enclosure number to the user and requests that the user enter a user defined PIN.

In some embodiments, the PIN may be required to be of a particular length, for example 4 digits, and of particular characters, for example only numbers. In other embodiments the user, not the kiosk system 100, decides and defines how many characters the PIN will have and what characters shall make up the PIN (alphanumeric characters, symbols, numbers). When the PIN length is made determinable by the user, the user has the freedom to use his 5 digit ZIP Code, a 10 digit phone number or perhaps a 3 digit house number or whatever PIN is easiest for the user to remember. If alphanumeric characters are allowed, the user may use a street name, a favorite word, or in some embodiments, symbols such as icon symbols for a dog, cat and a mouse, geometric shapes, colors, etc. After the user finishes entering his user defined PIN, the user completes the task by pressing an “enter” or other similar type of GUI button, at which time the kiosk system unlocks and pops open the designated securable enclosure in one of the locker columns 116.

When the designated securable enclosure 106 is unlocked and its door is popped open, the user may proceed to the open door and place objects for storage in the securable enclosure. The user then closes the locker door. Upon closing the door, the securable enclosure 106 will be locked.

At a later time during the rental period, the user may return to the kiosk 102 and indicate, via the GUI, that he would like to open the rented securable enclosure. The user then enters the securable enclosure number along with the previously user defined PIN. The system 100 determines whether the locker designation and the PIN provided by the user go together. If the provided locker designation and PIN code go together then the kiosk system 100 unlocks and pops open the designated locker 106 so that the user can remove the items that were stored therein.

Additional locker columns 117 comprising additional securable enclosures of the same size or of different sizes can be added or attached to the original locker columns 116 of this exemplary locker system 100 to increase the total number of securable enclosures 106 and/or sizes of securable enclosures available to users of the electronic locker system 100.

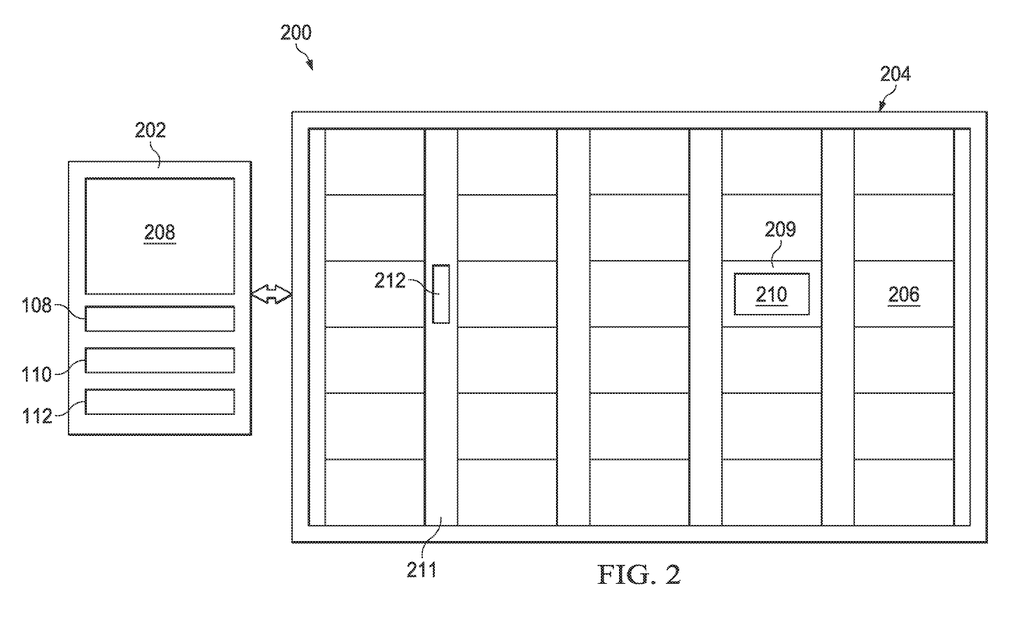

FIG. 2 depicts another embodiment of a locker system 200. This locker system 200 provides a kiosk 202 that may either standalone or be attached or incorporated into the plurality of locker columns 204 each having a plurality of securable enclosures 206. The kiosk 202 comprises a touchscreen 208 that displays a GUI for the user to interact with. The kiosk 202 further provides a bill acceptor 108, a credit card reader 110 and a receipt printing device 112 to aid a user in completing a rental transaction with the kiosk. In this embodiment, after the user completes the locker rental process by paying for the rental, obtaining a locker number, and setting a PIN for the rented securable enclosure, then locker system 200 may unlock and pop open the rented securable enclosure 206 for the user. In other embodiments, the user may, via the kiosk 202 request that the particular rented securable enclosure 206 be unlocked and popped open or may go to the location of the securable enclosure 206 having the particular rented locker number or locker designation and use a keypad (touchscreen or touch panel) incorporated into either a locker enclosure panel section 209 or a side panel portion 211 next to a plurality of lockers or column of lockers to enter the securable enclosure designation number and then the user defined PIN that has been associated with that particular securable enclosure. Any locker enclosure panel section keypad 210 or side panel portion keypad 212 may be used to open any of the securable enclosures in the electronic locker system provided the correct enclosure number and PIN combination is entered.

As seen in FIG. 2, a side panel or vertical channel touchpad 212 is located on one of the side panels or vertical channels 211 of a single locker column. The vertical channel touchpad may be a small LED or OLED based touchpad GUI or a touchpad with an array of buttons or sensors along with a small display that is used to interact with the user. In other embodiments the locker panel touchscreen 210 may be provided and incorporated into a locker location 209 of a the column 204 of securable enclosures or lockers. The locker panel touchscreen 210 may replace or be in place of one of the securable enclosures in the particular column of securable enclosures.

A user who is retrieving articles from a rented securable enclosure may proceed to any touchpad or locker panel (208, 210, 212) touchscreen or keypad incorporated into the electronic locker system 200 and enter their securable enclosure number and associated user-defined PIN to open up their rented securable enclosure. By incorporating side column or locker panel keypads, touchpads or touchscreens into individual columns of securable enclosures, users do not have to wait in a line at a kiosk 202 to unlock their rented securable enclosure along with other users who are interested in initializing the process of renting a securable enclosure. In some embodiments, the side panel touchpad 212 or locker panel touchscreen 210 can only be used to unlock and open already rented securable enclosures, and cannot be used for renting or extending the rental of an already rented securable enclosure.

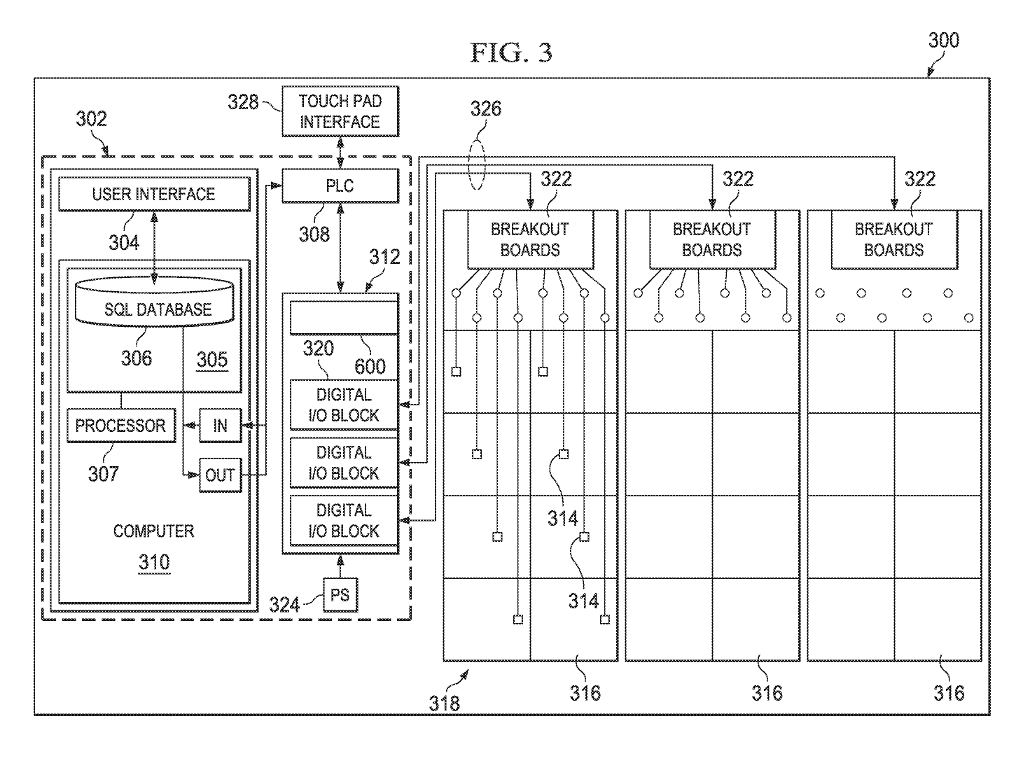

FIG. 3 depicts a circuit block diagram of an electronic locker system 300 that does not include a keypad on every securable enclosure of a locker column. This block diagram could be included in the embodiments shown in FIGS. 1 and 2. The exemplary kiosk 302 is shown to have a user interface 304. The user interface 304 may include a touchscreen, bill acceptor, credit card acceptor, receipt printer, change receptacle, touchpad and an identification reader. The kiosk 302 may also include a computer device 310 or microprocessor-based circuit comprising memory storage 304 in the form of an electromechanical device such as a hard drive, CD or DVD drive and/or a solid-state device such as a memory circuit, flash memory, RAM device or any non-transitory computer readable medium. Here the computer further comprises software, stored in the memory storage or non-transitory computer readable medium. The software may be used by the computer to operate and/or function as a database 306. Additional software stored in the non-transitory computer readable medium of the computer may be configured to enable the microprocessor 307 of the computer 310 to interact with the user interface devices and other circuits thereby sending and receiving information to and from the GUI and other user interface devices 304 on the kiosk 302.

In one embodiment the database software 306 is a SQL database. The database, which will be explained in more detail below, contains a listing of all the addresses or ports associated with all the securable enclosures 216 in the locker system 300. In the database there is associated with each securable enclosure address a status of the securable enclosure along with a history of transactions, time rented, along with other present and historical data information associated with each securable enclosure 316.

The database communicates with a programmable logic circuit (PLC) 308, which operates as an interpreter between the computer database software 306 and the rest of the circuitry associated with the electronic locker system 300. The PLC 308 operates to interpret commands and information received from the computer 310 and then provide the interpreted commands and or information as coded digital messages to the securable locker I/O circuits 312. The PLC 308 also receives status and digital messages that originate from the securable locker I/O circuits 320 and or the computer 310 polling the status of the keypad circuits 328 (212, 210) located on the side panels 211 or in a locker panel 209 location. The PLC interprets such messages received from polling the keypads and user interfaces and or electromechanical locks 314 and then provides them to the computer as input for updating the database 306 or necessitating an instruction from the computer 310. The securable locker I/O circuits 312 comprise digital I/O blocks 320. Each of the digital I/O blocks 320 is configured to communicate digital messages between the PLC 308 and a predetermined number of breakout boards 322. In the embodiment shown, each locker column 318 has eight securable enclosures 316. Each breakout board 322 that is incorporated into each of the locker columns is configured to connect with eight securable enclosure locking mechanisms 314, one for each securable enclosure 316. In the embodiment shown, each digital I/O board 320 is configured to communicate via a single breakout board circuit 322 with up to eight securable enclosures' locking mechanisms. It is understood that in other embodiments each digital I/O block 320 may be configured to communicate with more than eight breakout board ports or addresses (of the electronic lock or locking mechanism on each securable enclosure).

In various embodiments the PLC 308, when instructed by the three 310, provides a digital message that comprises an address or port number of one of the securable enclosures 316 along with an instruction or payload. The digital I/O blocks 320 direct the digital message to the breakout boards 322 in a parallel manner such that each column of lockers 318 receives the digital message at its individual breakout board 322 at about the same time. The breakout boards send the received digital message to each of, for example, the eight electronic locks 314 in the locker column 318. In this type of embodiment the electronic lock 314 that has a digital address that matches the address or port number in the digital message will receive and accept the digital message. The specific electronic lock 314 that accepts the digital message will then perform the action contained in the instruction or payload portion of the digital message. For example, the payload or instruction can be configured to direct the securable enclosure's electronic lock to unlock and pop open the door to the securable enclosure. In another example, a red light on the exterior of the electronic lock 314 may be illuminated on a closed securable enclosure so as to indicate indicating that the particular securable enclosure has been rented or is in use.

In other embodiments, the breakout board circuits 322 on each locker column 318 are configured to determine whether the address or port number of the digital message received is directed to one of the securable enclosure locking mechanisms 314 in the locker column associated with the breakout board. If the message is intended for one of the electronic locks 314 in the particular locker column 318 of the breakout board 322, then the breakout board 322 is configured to receive the digital message instruction and provide the digital command to the associated securable enclosure 316 and its associated electronic locking mechanism 314. Such digital commands may include commands to unlock and pop open the door, illuminate a particular color light indicating that the securable enclosure is rented, not rented or out of order.

The power supply 324 within the kiosk 302 provides power for at least the PLC 308 and the securable locker I/O circuits 312. Additionally, the digital locker I/O circuits 320, which are part of the securable locker I/O circuits 312, provide power to the breakout boards 322 of each column of lockers 318 and in turn power to the electronic locks 314 on each securable enclosure 316. Thus, none of the individual locker columns 318 require power connections to a power outlet or require an internal power converter or power supply that is connected to a wall outlet or other electrical power source. Each locker column 318 only requires a wired connection to the kiosk 302 via the data cable 326 connected between the breakout board 322 and a digital I/O block 320. An advantage to this design is that, if an individual column of lockers 318 has an electronic failure, is in need of repair, or the addition of an additional locker column is needed in the particular location, then the removal of an individual locker column and/or addition of one or more locker columns is a simple modular removal and addition of one or more locker columns 318. That is, each locker column 318 can be removed as a locker column and replaced with another locker column by merely disconnecting one data/power cable connected 326 to the breakout board of the locker column. The the data/power cable 326 is reconnected to the replacement, repaired or new locker column when the locker column is installed in the removed locker column's place.

Additionally, electronic locker system embodiments can be expanded by adding additional digital I/O block 320 s to the secure locker I/O circuit board 312 and connecting each additional digital I/O block 320 to additional locker column's breakout boards 322. The additional digital I/O blocks through 20 may be incorporated into the kiosk circuitry.

One or more touchpad interfaces 328 may be connected, in some embodiments, to the PLC 308. A touchpad 328 may be incorporated into a locker column 318 such that a user may interact with the touchpad interface 328 to open a rented securable enclosure 316 rather than be required to use the user interface 304 and GUI on the kiosk 302. The PLC 308 interprets inputs from the touchpad interface 328 and provides them as touchpad data to the database program running on the processor 307 in the computer 310. The computer 310, using the database program, the database 306 in the touchpad data, determines whether the touchpad data provides a match between an entered securable enclosure number and its associated PIN stored in the database 306. If there is a match between the user entered touchpad data and an entry in the database 306, then computer provides an instruction to the PLC 308, which in turn is sent to the appropriate electronic lock in order to, for example, open the particular securable enclosure that the user rented.

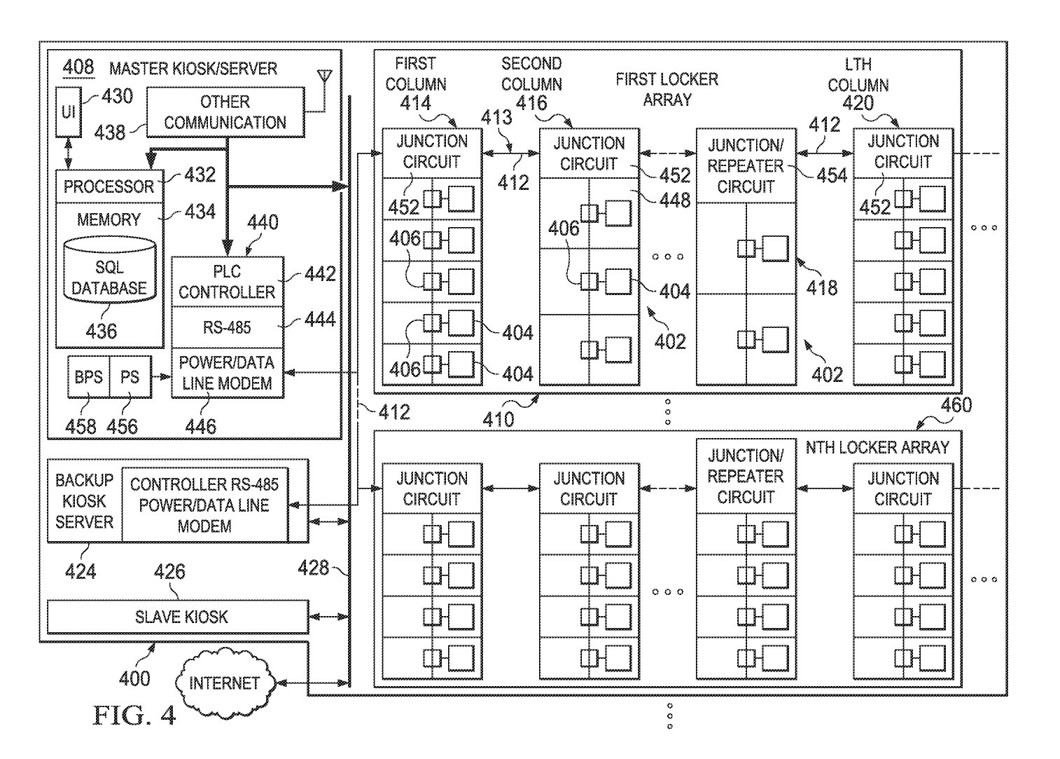

FIG. 4 provides a system block diagram of another electronic locker system embodiment 400 wherein each of securable enclosures 402 comprises its own dedicated keypad 404 configured for enabling a user to, among other things, unlock a rented securable enclosure 402. Some embodiments comprise a master kiosk 408 connected to the first locker array 410 via a modulated power and data line 412. The first locker array 410 comprises a plurality of locker columns 414, 416, 418, 420, 422 that are connected electronically in a daisy chain manner to establish the first locker array 410. Each locker column 14, 416, 418, 420, 422 may comprise one or more securable enclosures 402 that may be rented by a user. A locker system embodiment may also include one or more backup or redundant kiosk server(s) 424 and one or more slave kiosks 426 each connected to the master kiosk 408 by a network bus 428.

The master kiosk 408 may be separated from or mechanically attached or connected directly to the first locker array 410. The master kiosk 408 has a user interface (UI) 430 that may include, among other things, a touch sensitive screen, GUI, a cash or bill acceptor device, a credit card reader device, the receipt printer, various buttons, keypads, a mouse/rollerball or other cursor movement device and a user identification reader. The user interface 430 is connected to a processor or computer server 432 that has associated memory 434 that comprises a non-transitory computer readable medium for storing one or more programs comprising instructions operable on the computer server 432. Computer server 432 is configured to operate and run programs or other applications stored or partially stored in the associated memory 432 that are associated with the electronic locker system 400. Within the memory 434 of the computer server is a database program and associated database memory 436 configured to run on the computer server 432 and keep track of all the securable enclosures 402 in the locker system 400, their status, history, PIN, and other related data within the electronic locker system 400.

Communication circuitry 438 configured to communicate via one or more of various wired and wireless communication systems such as, but not limited to, Wi-Fi, a mobile communication network, Internet, radiofrequency identification (RFID), near field communication (NFC), infrared, RF, and/or a publicly switched telephone network (PSTN) is connected to the to the processor 432 via the network bus 428 or other connection. The communication circuitry 438 enables the master kiosk 408 to utilize various wireless forms of communication between the master kiosk 408, a user's wireless or wired communication device, another kiosk 442, 426 or any another designated computer system that is connected to a communication system. For example in some embodiments, the master kiosk 408 may be configured or adapted send a text message (SMS, MMS, or other text message format) to a user's mobile device via a wireless communication system in order to provide the user with their rented securable enclosure number and associated user defined PIN instead of printing out the information on a paper receipt.

Digital I/O circuitry 440 is located within the master kiosk 440 and connected to the processor 432 by the network bus 428 were other reasonable data connection. The digital I/O circuitry 440 may include a PLC controller 442 and an RS-485 circuit 444. The PLC controller 440 is configured to act essentially as a translator between the master kiosk processor 432 running the day-to-day software programs and the RS-485 circuitry 444. The RS-485 circuitry 444 enables a configuration of local networks and multidrop communication links between the master kiosk 408 and the locker columns 414-422 or in some embodiments individual securable enclosures 402. It should be understood that although the RS-485 circuitry 444 is a communication standard that defines the electrical characteristics of certain drivers and receivers for use in balanced digital multi point systems, the data rate or speed, the data format, and protocol of the data transmission is not specified by the RS-485 communication standard.

The RS-485 circuitry 444, in one embodiment, is configured to control a predetermined number of electronic locks 406. In some embodiments the predetermined maximum number of addresses of electronic locks or securable enclosures that can be controlled by a single RS-485 circuit 444 is 123 addresses. Other embodiments may comprise a single RS-485 circuit that controls a greater number of devices by enabling a larger number of addresses that may be utilized. To increase the number of securable enclosures 402 that can be controlled by a master kiosk 408, additional RS-485 circuits 444 can be added to the digital I/O circuitry 440.

The RS-485 circuitry 444 provides its RS-485 signal to a power/data line modem 446, which provides a modulated power and data signal onto the modulated power/data line 412. In some embodiments, the modulated power/data line 412 is provided on a standard CAT-5 or CAT-6 cable. The power/data line modem 446 provides 5V DC, which can be used by the plurality of electronic keypads 404 and electronic locks 406 in the locker array. The power/data line modem 446 also provides the data signals that are formed by having both an address and an instruction or payload. The address of each data signal will coincide with a particular keypad 404 and/or locking mechanism 406 of a securable enclosure within the first locker array and may coincide with a particular keypad and lock of a particular securable enclosure or any securable enclosure within any locker array of an exemplary electronic locker system 400. The first locker array 410 may have up to the maximum number of securable enclosures as defined by the maximum number of addresses that may be addressed by the RS-485 circuit 444.

An array of lockers, such as the first locker array 410, includes a plurality of columns of lockers 414-420. There can be L columns of lockers in an array. Each locker column has a plurality of securable enclosures 402. For example in FIG. 4, the first locker column 414 has five small securable enclosures 402, the second locker column 416 has three medium-size securable enclosures 448, and the fourth locker column has two large securable enclosures 450. Each securable enclosure 402, 448, 450 includes a keypad 404 that is accessible on the outside or adjacent to its associated securable enclosure. Each securable enclosure 402, 448, 450 also includes an electronic lock mechanism 406 that is electrically connected or in communication with its associated keypad and configured to lock or unlock a securable enclosure door in accordance with an instruction or payload portion of a properly addressed data signal from the RS-485 circuitry 444. The securable enclosure door can be opened or closed by a user when the door's electronic lock is unlocked. The each keypad 404 is electrically connected to the electronic lock 406 of the particular securable enclosure. Each electronic keypad 404 within a locker column 414-420 is electrically connected to either a junction circuit 452 or a junction/repeater circuit 454 on the respective locker column 414-420.

The modulated power/data line 412 is connected between the power data line modem 446 of the master kiosk 408 and the first locker column 414 in the first locker array 410. In particular, the modulated power/data line 412 is connected to a junction circuit 452 in the first locker column 414. The power data line 412 is then daisychained 413 between the first junction circuit 452 on the first locker column to the second junction circuit 452 on the second locker column 416. This daisy chaining 413 of the junction circuits 452, in the first and second locker columns 414, 416 continues (as indicated by the dashed daisychain connection 415) for a predetermined number of locker columns M. After the predetermined number M of locker columns, for example three locker columns, a junction/repeater circuit 454 is required to boost the strength of the data signals on the daisychained modulated power/data line 415 so that the data signals can be transmitted through another, for example, three junction circuits. Thus, in an exemplary locker array 410 there can be as many locker columns as desired as long as the maximum number of addresses of the particular RS-485 circuit is not exceeded and provided that for every predetermined number M of daisychained junction circuits 452 there is at least one junction/repeater circuit 454 included in the daisychain. In other words, between every M junctions circuits 452 on the power/data line 412 there is a junction/repeater circuit 454.

The power supply 456 and backup power supply 458 within the master kiosk 408 provides power to at least the power/data line modem 446 and the other circuits in the digital I/O circuitry 440. Additionally, the power supply 456 within the master kiosk 408 provides power to the modulated power/data line 412 and in turn all the junction circuits 452, junction/repeater circuits 454, keypads 404 and electronic locks 406 in the first locker array 410. This configuration allows each locker column 414-420 to be placed together with other locker columns or separately from other locker columns without each requiring individual electrical power from a wall socket or other power source. All power for the securable enclosures 402 within the first locker array 410 is provided by the master kiosk 408.

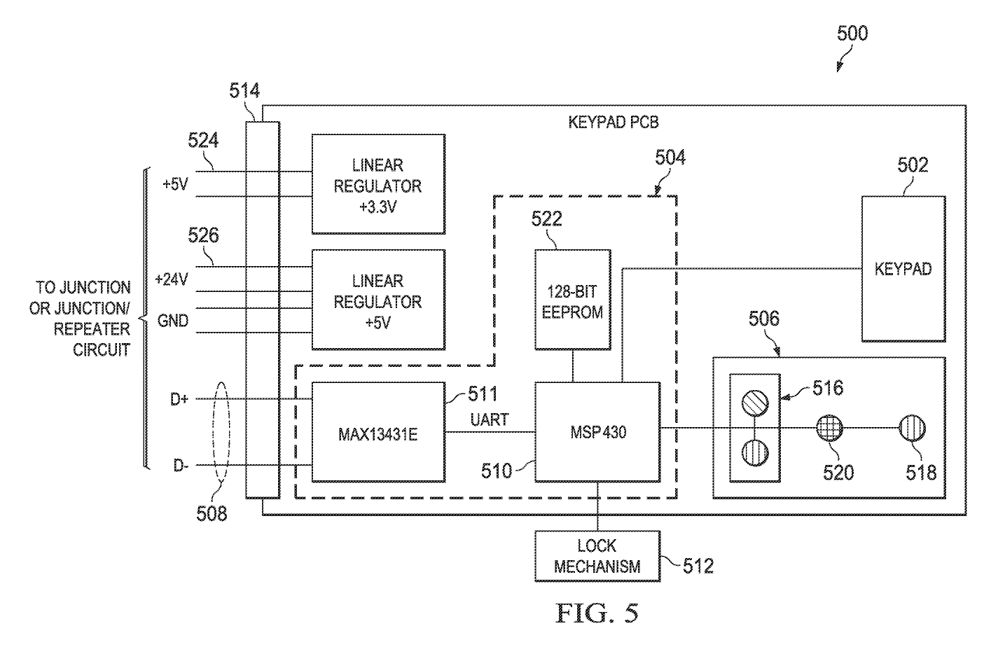

FIG. 5 depicts a block diagram of an exemplary keypad and lock circuitry block diagram 500 for use on each securable enclosure 402. The keypad and lock combination 500 are powered and in electrical communication with the junction or junction/repeater circuit found on each locker column 414-420 in, for example, the first locker array 410. The keypad and lock circuitry 500 is designed and built to allow for communication with the exemplary locker system kiosk and to be integration into the locker columns in the locker system arrangement. The keypad 502 is of a sealed design such that the keypad 502 is sealed against dust and water ingress in accordance with NEMA3/NEMA4 compliance, which is not required but is used as a good practice guideline for the desired performance and lock life expectancy in varying hot, cold, wet, humid, dusty and dry environments.

A single keypad printed circuit board (PCB) 500 can be used to implement the keypad interface 502 and keypad communication circuitry 504. An exemplary keypad 502 has 14 buttons being, the digits 0-9, ‘clear’, ‘open’, ‘yes’ and ‘no’. The keypad 502 may be also capable of identifying a simultaneous dual press of both the ‘clear’ and ‘end’ buttons or another predetermined button combination. In most circumstances only one digit may be pressed and recognized at any time. The overlay on the keypad can be a screen printed overlay that identifies the buttons and also incorporates a notification text window or display with the text “Stop Renting?” LEDs or other illumination technology 506 are used to illuminate the “Stop Renting” text window to present this option to the user when needed.

Some tactile feedback on the keypad buttons can be included. In one embodiment, snapdomes are utilized for the buttons. Snapdomes typically have a life cycle of between 1 and 5 million activations (however the PCB will be required to be built with durable plating—electroless nickel or electro-deposited gold and will likely be the weak point for lifecycle limitation, the keypad may be built with electroless nickel immersion gold (ENIG) PCB plating). In other embodiments, haptic feedback can be incorporated into each keypad PCB 500, when capacitive or other more durable touch sensitive keypad buttons are used.

In some embodiments, the keypad and lock circuitry 500 is configured to communicate with the remainder of the locker system via a half duplex RS485 over a single twisted pair 508. A MAX13431 RS485 to UART part may be used to relay communications between the system bus and the on board keypad microcontroller 510. The keypad and lock circuitry 500 will not be required to initialize communication but will be polled by the PLC 440 or Kiosk processor 432 via the power/data line 412. The keypad PCB 500 never initiates communication on the communication bus with the rest of the system. As such, polling of the keypad PCB 500 via the twisted-pair communication lines 508 is necessary for installation and operation of various embodiments of the present locker system.

The keypad PCB 500 may comprise a Molex connector or other electrical connector in order to electrically connect with the electromechanical mechanical locking mechanism 512. The keypad PCB 500 may include an RJ45 connector or other electrical connector 514 for connecting to the modulated power/data bus via a junction circuit.

The keypad PCB 500 has LEDs 506 for the purpose of providing visual feedback to the user. These LEDs may be mounted on the rear of the PCB and be configured to emit light through a slot on the PCB to reduce clearance issues on the snapdome or keypad button side of the PCB. The LEDs include a bicolor LED 516 arrangement having read and green selectable colors, a single Red LED 518 and a single Amber LED 520 for system state feedback that will be viewable by a user. There may also be three Red LEDs (not specifically shown) to illuminate the “Stop Renting?” display section.

The keypad PCB 500 must hold its securable enclosure ID locally in non-volatile memory 522 such as EEPROM or flash memory device. Its ID is linked to the physical locker location and is assigned manually when the system is first installed or during a regular system service. The PIN associated with the securable enclosure ID is stored in the main system data base at the master kiosk and may be requested from the keypad PCB 500 when the user interacts with the securable locker enclosure 402 six (and the locker is polled recognizing that the user interacted with the locker).

In various embodiments, each keypad and lock system 500 on a securable enclosure 402 may use a SouthCo rotary lock (R4-EM-13-161) as the electromechanical locking mechanism 512. The locking mechanism 512 has a switch that indicates its current state of being locked or unlocked. The locking mechanism 512 may not be opened locally by the keypad PCB 500 as it must communicate back to the main system and database 436 when being polled for permission/authentication. The communication is performed by each keypad PCB 500 when polled by the PLC 442 of its present state. The state of each keypad PCB 500 is then provided to the database software 436, via the PLC 442, and interpreted accordingly.

The keypad PCB 500 can be configured to be visible in poor lighting conditions or for short term instances of complete darkness. Photo luminescent ink may be a viable alternative to full illumination of the keypad's 502 buttons with LEDs. Additionally, an OLED touch sensitive display may be utilized in some keypad PCB embodiments instead of a mechanical pushbutton keypad.

The keypad PC 500 B is powered from the power/data line 412 that is connected to each locker column 414-420 serial the via the junction circuit 452 or junction/repeater circuits 454. The keypad PCB 500 receives a 5V DC line 524 and a 24 DC 526 line to control and power the keypad PCB 500 and associated electromechanical locking mechanism 512. By using a 5V system, the voltage can be easily established by a linear voltage regulator, which can be used to power the 3.3V keypad PCB circuits efficiently while keeping manufacturing costs down. The LEDs 506 may be driven directly from the 5V or from the regulated 3.3V line. Since the RS485 system power and data bus requires 5V, the Keypad PCB 500 may be driven directly from the 5Vdc system line or the keyboard PCB 500 could incorporate, as an alternative, a 24V DC to 5V DC linear regulator if the reliability of the 5Vdc line is questionable due to line noise or random voltage drops in an embodiment of the system.

The keypad PCB 500 can be configured to communicate with the master kiosk and the PLC 442 via a half duplex RS-485 protocol over a single twisted pair 508. The keypad PCB 500 may include a UART 511 to relay communications between the system power/data line 412 and a microcontroller 510 that is included on the keypad PCB 500. The keypad PCB 500 is not required to initialize communication. Instead, the keypad PCB 500 is polled for information or a change in state. In some embodiments the communication protocol used over the RS-485 power/data line 412 will be a ModBus protocol.

As per the ModBus protocol, frames are delineated by a 3.5 cycle delay on the bus. After this delay, a slave (i.e., a keypad PCB 500) will process the frame. If or when an address in the mod bus protocol matches the address or identification stored in the memory 522 of the of the keypad communication circuitry 504, then the keypad PC the 500 will respond and/or perform an instruction provided in the frame of the communication. In various embodiments, communications over the power/data bus 412 can be set for the baud rate of 115,200 with 8 data bits, no parity bits and 1 stop bit.

Each keypad circuit 500 is programmed or manually programmed with its keypad number (physical securable enclosure number) when a locker column or array of locker columns are installed. When a keypad circuit 500 for a securable enclosure 402 is booted or turned on for the first time in an exemplary electronic locker system 400, the keypad circuit 500 boots into a service mode. Additionally, the database program 436 can push the keypad PCB 500 into a service mode at any time. When in service mode, the keypad PCB circuitry 500 waits for a dual “clear” and “end” button push on the keypad 502. A dual “clear” and “end” button push puts the keypad circuit into assignment mode wherein the keypad number (i.e., the physical securable enclosure number) is entered followed by a pressing of the “open” button on the keypad. This entered keypad number is then saved in nonvolatile memory of the keypad circuit, such as the EEPROM 522, but can be updated reassigned by following the same procedure at a later time.

Each keypad PCB circuit 500 also has a “slave address”, which can be any number between one and the maximum number of addresses that the digital I/O circuit can address. For example in one embodiment the maximum number is 123, in yet other embodiments the number can be higher such as 255. In yet other embodiments the maximum number of addresses can be different. During the first boot/securable enclosure installation process after the physical securable enclosure number or keypad number is assigned, the first keypad circuit (the keypad with the lowest keypad number) on the bus will broadcast to all the keypad circuits in the locker array it's keypad number. Each of the other keypad circuits in the locker array will then automatically calculate their slave address by subtracting the first number −1 from their keypad number. For example, if a first keypad PCB 500 in the first locker array 410 is assigned a keypad number or physical securable enclosure number of 543, and the first physical securable enclosure number (the lowest keypad number) of the locker array is 500, then the slave address of locker number 543 is calculated as 543−(500−1)=44. Similarly the slave address of the first securable enclosure number, 500, will be 1.

Each keypad PCB 500 supports keypad function code 3 (0X03-Read Multiple Registers) and function code 16 (0X10-Write Multiple Registers). The available functions are detailed below with examples.

Read Registers (Function Code 3)

| Address | Function | Register Address | | # Registers | | CRC | |
|---|---|---|---|---|---|---|---|
| 0xXX | 0x03 | 0xXX | 0xXX | 0xXX | 0xXX | 0xXX | 0xXX |

Example:
Poll locker number 44:

| | | | | |
|---|---|---|---|---|
| Address | Function | Register Address | # Registers | CRC |

| | | | | | | | |
|---|---|---|---|---|---|---|---|
| 0x2C | 0x03 | 0x03 | 0xE7 | 0x00 | 0x01 | 0x04 | 0x32 |

Write Registers (Function Code 16)

| Address | Function | Register Address | | # Registers | | Data | CRC | |
|---|---|---|---|---|---|---|---|---|
| 0xXX | 0x10 | 0xXX | 0xXX | 0xXX | 0xXX | N-words | 0xXX | 0xXX |

Example:
Broadcast the first locker number 500 to all keypads:

| Address | Function | Register Address | | # Registers | | Data | | CRC | |
|---|---|---|---|---|---|---|---|---|---|
| 0x00 | 0x10 | 0x00 | 0x00 | 0x00 | 0x01 | 0x01 | 0xF4 | 0x1D | 0x00 |

Each keypad circuit 500 responds to all function calls addressed to it, although broadcast commands (slave address 0X00) will not be responded to. Normal keypad circuit responses (no error occurred) are listed below.

Read Registers Response (Function Code 3)

| Address | Function | # Bytes | Data1 | | Data N | | CRC | |
|---|---|---|---|---|---|---|---|---|
| 0xXX | 0x03 | 0xXX | 0xXX | 0xXX | 0xXX | 0xXX | 0xXX | 0xXX |

Write Registers Response (Function Code 16)

| Address | Function | Register Address | | # Registers | | CRC | |
|---|---|---|---|---|---|---|---|
| 0xXX | 0x10 | 0xXX | 0xXX | 0xXX | 0xXX | 0xXX | 0xXX |

Exceptions can be made as per the ModBus protocol. A CRC error in the received frame can receive no response from a keypad circuit and the RS-485 circuit (the master bus circuit) can process a timeout error. A valid frame that cannot be handled by the keypad PCB 500 can return an error code identifying the problem.

An error response can be identified by setting the MSB of the function code (adding 0X80) and leaving it otherwise unchanged. The data field can then be replaced by an exception code to define the error. Supported exception codes for the exemplary embodiment in accordance with the ModBus are outlined below:

| Code | Name | Description |
|---|---|---|
| 01 | Illegal Function | Function Code unsupported by Keypad |
| 02 | Illegal Data Address | Invalid Keypad data register address |
| 03 | Illegal Data Value | Invalid data for selected Keypad register |
| 04 | Slave Device Failure | Unrecoverable error while performing requested action |
| 05 | Acknowledge | Request received but long processing expected |
| 06 | Slave Device Busy | Slave busy processing earlier command, message ignored |

Road RegistersException Response (Function Code 3)

| Address | Function | Exception Code | CRC | |
|---|---|---|---|---|
| 0xXX | 0x83 | 0xXX | 0xXX | 0xXX |

Write Registers Exception Response (Ftmction Code 16)

| Address | Function | Exception Code | CRC | |
|---|---|---|---|---|
| 0xXX | 0x90 | 0xXX | 0xXX | 0xXX |

In one embodiment, registers in a keyboard PCB 500 associated with the first locker array 410 start at a first address address 4001, this location is addressed as 0X0000. The remaining registers in the first locker system 410 are counted up from this first address number. A list of available registers for this embodiment is shown below:

Register Addresses List

| Register | Address | Description | Read/Write |
|---|---|---|---|
| 4001 | 0x0000 | First Locker Number | R/W |
| 4002 | 0x0001 | Keypad Return State after Command | W |
| 4003 | 0x0002 | Issue Kaypad Command | W |
| 5000 | 0x03E7 | Keypad Status Register | R |
| 5001 | 0x03E8 | PIN Low Bytes (1^{st} digit-2^{nd} digit) | R |
| 5002 | 0x03E9 | PIN Med Bytes (3^{rd} digit-4^{th} digit) | R |
| 5003 | 0x03EA | PIN High Bytes (5^{th} digit-6^{th} digit) | R |
| 5004 | 0x03EB | Locker Number | R |
| 5005 | 0x03EC | Keypad State Machine State | R |

For keypad PCB commands, when a command value is written to, for example register 4002, the keypad circuit 500 will execute a task and move to a new state as instructed. The command value is written to register 4002 and the system must also write the return state to register 4003. Valid commands are listed below:

| Command | Name | Description | Next State |
|---|---|---|---|
| 0x0001 | Change State | Move to a new state | Return State Register |
| 0x0002 | Invalid Pin | Most recent pin entry | Return State Register |
| | | was invalid | |
| 0x0003 | Open Door | Valid pin entry, open | Return State Register |
| | | the door | |
| 0x0004 | Reboot* | Restart the keypad | — |

*On reboot the keypad will automatically enter Out Of Service mode

After the keypad PCB 500 of the securable enclosure keypad PCB 500 executes the required command, it will then enter the specified return state. Below is a list of keypad PCB 500 states:

| Value | Name | Description |
|---|---|---|
| 0 | Error* | Put out of service by keypad-internal |
| | | keypad error |
| 1 | Data Pending* | Handling system ModBus message |
| 2 | Service Mode | General service and repair mode |
| 3 | Assignment* | Assign new locker number-entered |
| | | from Service Mode |
| 4 | Out of Service | Put out of service by the system |
| 5 | Available for Rent | Available but unassigned |
| 6 | Assigned | Assigned but not yet accessed |
| 7 | Rented | Rented and locked by user |
| 8 | Multi-Day Rental | Rented and locked by user |
| 9 | Expired | Exceeded allocated time |
| 10 | Locked | Invalid Pin entered too many times |
| 11 | Invalid Pin** | Notifying user of invalid pin |
| 12 | Door Open** | Door is open |

NOTE:
Not all states can be explicitly written to the Return State Register
*The keypad cannot be commanded by the system to explicitly enter these states.
**Cannot be set by use of the Change State Command (0x0001).
These states are automatically entered when their respective commands are called; in this case the Return State must be set to the state desired after these commands are completed.

Each keypad PCB 500 must be polled to determine its status. To determine the current status of a keypad circuit 500 and respond to a user request (such as the user pressing a button on the keypad of a securable enclosure), the RS-485 circuitry 444 sequentially polls all keypad PCBs on the power/data bus 412. The polling process consists of a single read of each keypad PCB's status register.

Request

| Address | Function | Register Address | | # Registers | | CRC | |
|---|---|---|---|---|---|---|---|
| 0xXX | 0x03 | 0x03 | 0xE8 | 0x00 | 0x01 | 0xXX | 0xXX |

Response

| Address | Function | Byte Count | Register Data | | CRC | |
|---|---|---|---|---|---|---|
| 0xXX | 0x03 | 0x01 | 0xXX | 0xXX | 0xXX | 0XXX |

Keypad Status Register
Upper Byte:

| | | | | | | | |
|---|---|---|---|---|---|---|---|
| Rsvd | Rsvd | Rsvd | Rsvd | Pin | Pin | Pin | Pin |
| | | | | Length | Length | Length | Length |

In various embodiments a PIN can have a length of 1 to for example 15 digits. The PIN length can be defined by the user at the time user is renting a securable enclosure 402 and selecting a PIN for use with the rented securable enclosure. Additionally, the user may rent a plurality of securable enclosures at the same time and set all of the rented securable enclosures to have the same PIN via the GUI. This enables the user to remember or keep track of the PIN much more easily when multiple lockers are rented simultaneously. An eight bit nibble that is stored in the database 436 can indicate the length of the entered PIN. The same eight bits may also include information about a particular enclosure that includes the enclosure's service state, rental state, door state and PIN state, which may be found in just four first four bits while the remaining four bits are used and reserved to indicate the length of the PIN that was selected by the user (when a securable enclosure is in a rented state). To be understood that the order of these eight bits and what the bits represent may be in any order. The reservation of four bits for the pin length and four bits for the enclosure's service state, rental state, door state and pin state are shown in one configuration below.

Lower Byte:

| | | | | | | | |
|---|---|---|---|---|---|---|---|
| Rsvd | Rsvd | Rsvd | Rsvd | Service | Rental | Door | PIN |
| | | | | State | State | State | State |

Reserved (MSB)
Reserved
Reserved
Reserved
Service State:
1 = Out of Service
0 = In Service
Rental State:
1 = Stop Rental Requested
0 = No request pending
Door State:
1 = Door Latch Opened
0 = Door Latch Closed
PIN State:
The LSB of the Keypad Status Register is the PIN State which indicates whether or not a PIN has been entered and is available for authentication.
1 = PIN Entered, Open Requested
0 = No request pending

The following is an example of a full communication sequence between a kiosk 408 and a keypad PCB 500 of a securable enclosure 402 that has a valid locker number set at 543 in a locker array wherein the first physical locker number is 500.

Broadcast First Locker Number of 500 to all keypads on the bus:

| Address | Function | Register Address | | # Registers | | Data | | CRC | |
|---|---|---|---|---|---|---|---|---|---|
| 0x00 | 0x10 | 0x00 | 0x00 | 0x00 | 0x01 | 0x01 | 0xF4 | 0x1D | 0x00 |

Keypad with locker number 543 now has a slave address of 44 (0x2C) and is in available mode.
Tell the keypad it has been assigned:

| Address | Function | Register Address | | # Registers | | Data | | CRC | |
|---|---|---|---|---|---|---|---|---|---|
| 0x2C | 0x10 | 0x00 | 0x01 | 0x00 | 0x01 | 0x00 | 0x06 | 0x85 | 0xBF |

Poll until a pin is entered:

| | | | | |
|---|---|---|---|---|
| Address | Function | Register Address | # Registers | CRC |

| | | | | | | | |
|---|---|---|---|---|---|---|---|
| 0x2C | 0x03 | 0x03 | 0xE7 | 0x00 | 0x01 | 0x04 | 0x32 |

Keypad response when a 4 digit is entered:

| Address | Function | Register Address | | # Registers | | Data | | CRC | |
|---|---|---|---|---|---|---|---|---|---|
| 0x2C | 0x03 | 0x03 | 0xE7 | 0x00 | 0x01 | 0x04 | 0x01 | 0xA3 | 0xD7 |

Query the first 2 keypad PIN registers:

| | | | | |
|---|---|---|---|---|
| Address | Function | Register Address | # Registers | CRC |

| | | | | | | | |
|---|---|---|---|---|---|---|---|
| 0x2C | 0x03 | 0x03 | 0xE9 | 0x00 | 0x02 | 0xC6 | 0x13 |

Keypad response when a 4 digit pin of 1234 is entered:

| | | | | | |
|---|---|---|---|---|---|
| Address | Function | # Bytes | Data | Data | CRC |

| | | | | | | | | |
|---|---|---|---|---|---|---|---|---|
| 0x2C | 0x03 | 0x04 | 0x01 | 0x02 | 0x03 | 0x04 | 0x3E | 0xA6 |

Assuming the correct pin issue an open door command and set Rented as the next state:

| Address | Function | Register Address | | # Registers | | Data | | Data | | CRC | |
|---|---|---|---|---|---|---|---|---|---|---|---|
| 0x2C | 0x10 | 0x00 | 0x01 | 0x00 | 0x02 | 0x00 | 0x0C | 0x00 | 0x07 | 0x53 | 0x94 |

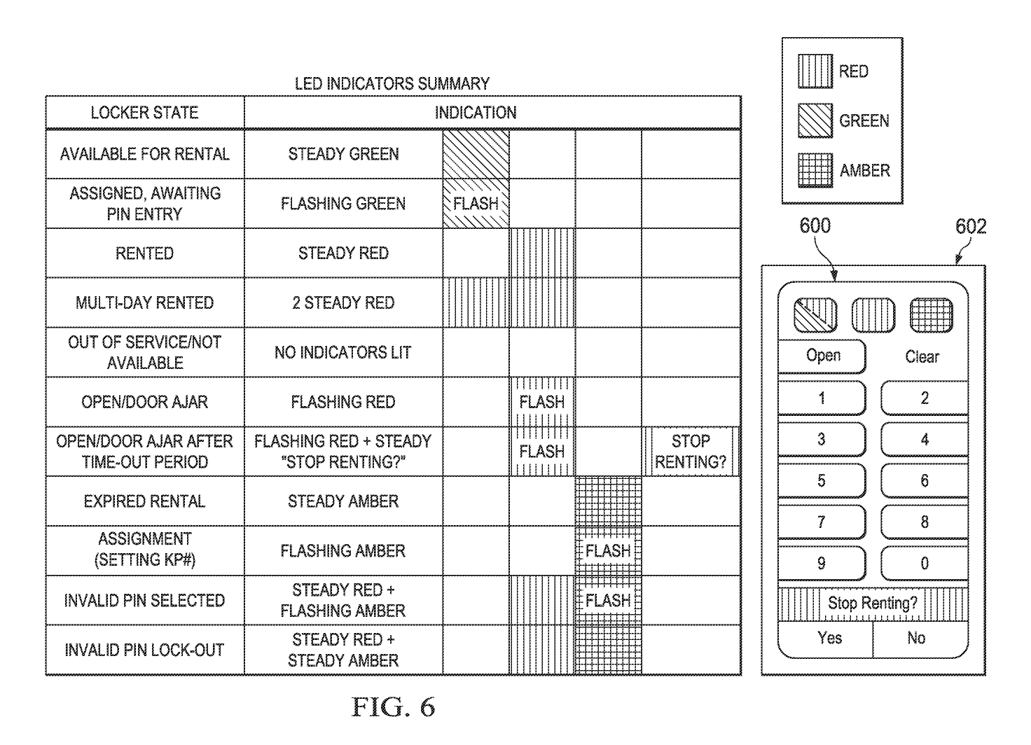

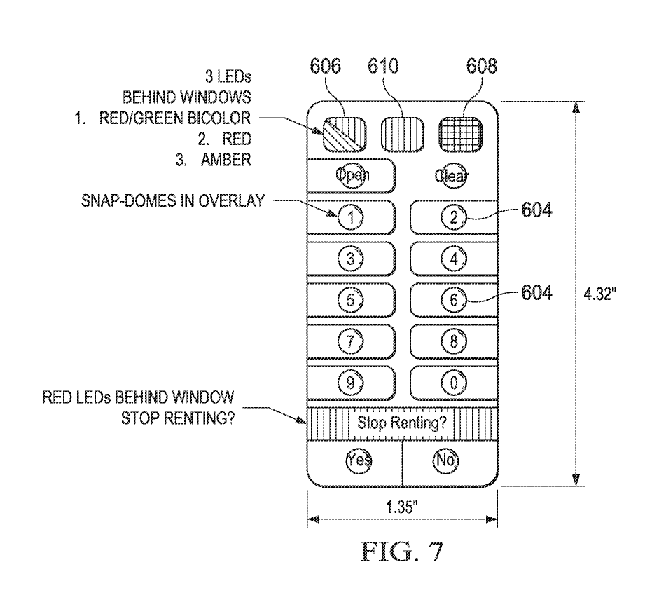

Referring now to FIGS. 6 and 7, an external keypad face 600 in accordance with an embodiment of the invention is shown. Each keypad face 600 may be positioned on a locker column's vertical channel 602 next to the door or opening of each securable enclosure in the locker column. Each keypad face or overlay 600 may include a plurality of button locations including numerals 0-9, “open”, “clear”, “yes” and “no”. Additionally there are three locations for light indicators, such as colored LEDs and a “stop renting?” area, which may be backlit buttons or comprise a programmable display button areas such as an OLED or LED touch sensitive display areas. In other embodiments, the entire keypad overlay may be created by an OLED or LED type touch display.

Behind the keypad face or overlay 600 are various pressure sensitive switches or capacitive switches 604 for receiving input from the user. There are also multicolor LEDs 606 and/or single color LEDs 608, 610 for backlighting various indicators as shown in FIG. 7.

The indicator LEDs 606, 608, 610 are lit up differently depending on the securable enclosure's state. Also in FIG. 6 is a chart prescribing one embodiment of how the indicators are lit for the various different states that each securable enclosure can be in.

In one embodiment, prior to a securable enclosure 402 being rented or when a securable enclosure 402 is available to be rented, its keypad face 600 will display a steady green indicator. Thus, all available for rental securable enclosures that have a steady green indicator lit do not respond to any keypad button presses by a user or potential user. When the locker system kiosk 408 has assigned a securable enclosure to a user, but the user has not yet opened the locker, the assigned securable enclosure will display a flashing green indicator light. When the user locates the securable enclosure that has been rented, the user enters his PIN on the assigned and rented locker displaying a flashing green indicator light on the keypad face 600. The green light becomes steady and blinks off briefly each time the customer presses the button buttons between 0-9. If the user correctly enters his selected PIN, the green indicator light flashes rapidly and continues to flash rapidly until the user presses the “open” button indicating to the keypad PCB 500 that the user would like the securable enclosure door to open. The keypad PCB circuit 500, upon being polled by the PLC system controller 442, which determines that the correct pin was entered for the particular securable enclosure and provides an appropriate signal over the power/data line 412 to allow the particular securable enclosure 402 to be opened, provides a signal to the electromechanical lock 512, 406 to unlock the securable enclosure. The securable enclosure door either pops open or can be opened by the user at this time. Once the securable enclosure's door is opened (the electromechanical lock is unlocked) a flashing red indicator light is displayed on the keypad to the user. At this time the user places articles to be stored inside the securable enclosure and closes the door. When the door is closed and the electronic lock latches in a locked position, the keypad displays a steady read indicator light indicating that the securable enclosure is in use and locked.

At some point in time after the user has closed the securable enclosure's door, the user may return to the rented securable locker and want to open the securable enclosure's door. Here, it should be understood that in some embodiments, the securable enclosure can be rented by the user as a single use securable enclosure or for a predetermined amount of time, whether it be an hour, a day, a week or a season. Thus, assuming in this example that the rental process is not a single use process, but instead the rental is for a predetermined amount of time, the user may return the locker with the intent to remove some items from the locker and/or to put additional items into the locker. As such, when the user returns to the rented securable enclosure with the rental still in progress, the steady red indicator light is displayed on the assigned securable enclosure keypad face 600 indicating that the particular locker/securable enclosure is rented. The customer begins entering the customer's PIN onto the keypad face 600 during which time the green indicator light blinks once with each button press or number entry. Meanwhile the red indicator light continues to remain on during entry of the PIN. After the PIN is entered, the user may press the open button, wherein after the securable enclosure's keypad circuit is polled by the PLC controller 442 and the customer entered PIN is compared with the stored PIN associated with the particular physical securable enclosure locker number. If they customer entered and previously stored PIN match, the system provides an unlock signal addressed to the particular securable enclosure. The keypad PCB receives the unlock signal and provides an appropriate signal to the associated electromechanical lock mechanism to unlock. Meanwhile, the green light flashes rapidly indicating that the correct PIN was entered and that the user can open the securable enclosure's door. Additionally, the red indicator light remains lit throughout this process thereby continuing to indicate that the particular securable enclosure is rented. Once the particular securable enclosure is opened, the flashing red indicator light is displayed indicating that the securable enclosure is opened.

While the particular securable enclosure door is open, and after a predetermined timeout period elapses, the “Stop Renting?” indicator may be back lit by a steady red indicator light. Meanwhile, the door open red indicator light continues to flash. The “Stop Renting?” indicator remains lit for a predetermined period of time (e.g., 10 to 15 seconds) after the user has closed the securable enclosure door if the user has not pressed the “yes” or “no” button to indicate whether or not the user wishes to continue renting that particular securable enclosure. If the user presses the “yes” button the “Stop Renting?” indicator turns off and the red indicator light turns off, while the green indicator light is turned on indicating that the securable enclosure is available for rental. Conversely, if the “no” button is pressed or the predetermined period of time expires, the system assumes that the particular securable enclosure is still being rented by the user and the red indicator light remains on and steady. It is understood that the “Stop Renting?” indicator does not turn on during the first time the locker is opened by the user who has just rented it.

In some circumstances, a user may return to the rented particular securable enclosure while the rental period is still in progress. In this situation, the red indicator is continuously on. When the customer begins entering his PIN, the green indicator light blinks once with each button press. Meanwhile, the red indicator light continues to stay steadily on. After the entire PIN has been entered, the open button (in some embodiments the “enter” button, not specifically shown) is pressed, but the system after polling the locker circuit of the particular securable enclosure determines that an invalid or nonmatching PIN has been entered, and an amber indicator light flashes a predetermined number of times rapidly (for example, 5 to 20 times) indicating to the entered PIN was not accepted as the correct PIN. Meanwhile, the red indicator light continues to remain steadily on indicating that the particular securable enclosure is still being rented. If an invalid PIN is entered a predetermined number of times (for example three times) in a row, then a steady amber indicator light is displayed to the user and the keypad circuit no longer responds to any button presses. At this time, the user will have to go to the kiosk or seek help from a customer service provider. Additionally, after a predetermined amount of time after the steady amber indicator light turned on, for example 2 to 15 minutes, the amber indicator light will turn off and the keypad circuit will again accept PIN entries from a user.

In some circumstances, the user may return to their rented securable enclosure after the rental period has expired. For example, the user may return to the securable enclosure a five hours after the user's three hour paid for rental period has expired. In various embodiments, when the rental period for a rented locker expires prior to a user removing his or her contents from the securable enclosure, a steady amber indicator light is displayed on the keypad. When a steady amber light is displayed, the keypad circuit is not respond to any button presses and the user must return to the kiosk to extend his rental by adding additional needed payment or payment units via the user interface.

In some embodiments, the user may want to rent a locker for multiple days or multiple 24 hour periods. A multiple day rental may be indicated on the keypad of the rented securable enclosure with two steady red indicator lights. Only one of the two red indicator lights will blink when the door of a rented securable enclosure is opened during a multiple day rental. The user can return to their rented securable enclosure to open and close it as often as they want during the time within the multiple day rental. When the user enters their PIN on the keypad, one of the red indicator lights is supplanted by a blinking green indicator light with each press of the keypad. The green indicator light operates in a similar manner as for a non-multiple day rental.

When setting up embodiments of a locker system in accordance with the invention, each securable enclosure of the locker system is assigned an external number that that user can view. An array of locker columns, a single locker column, a single/individual locker can be assigned or reassigned an external locker number during the assignment process. During the assignment process the amber indicator light on the keypad face 600 of each securable enclosure that is being assigned a external locker number flashes. In some embodiments this external locker number assignment state commences when both the “open” and “clear” buttons or another predetermined combination of buttons are pressed simultaneously for a predetermined amount of time on each the securable enclosure locker keypad base or faces to be assigned. The amber lights will continue to flash until the assignment process is completed.

Referring to the kiosks of FIGS. 1-4, each kiosk is adaptable to incorporate a wide variety of credit card or identification readers. Such readers, can be configured to be used to identify the user or potential user of an electronic locker system. If a user has a “credential”, such as an RFID, mobile phone, I-button, near field communication, barcode, fingerprint, voice recognition, human interface device (HID), etc., the kiosk can incorporate the appropriate reader device to authenticate the user in association with an ability to pay, as a member of a club, a blacklisted member, a guest, an identification number or by another identifiable means associated with the user within the database or be a communication to an external device either wirelessly or via a wired connection. An appropriate application programming interface (API) can be incorporated into the computer or server within the kiosk such that the identification reader on the kiosk can be integrated within the software within the kiosk and communicate with an external 3^{rd} party system to verify or authenticate users of the electronic locker system. The API enables the kiosk to interact with a third-party system via an Internet connection or wireless communication system electrically connected to the processor within the kiosk. By interacting with a third-party system, the credential of the user can be compared with acceptable credentials provided by a third-party system (not specifically shown in the figures), such as a computer system associated with a ski resort, hotel, club, bank, credit card company, or other party that will enable the kiosk to approve the user's use of the locker system and create an appropriate bill, charge or other historic data indication associated with the user's transaction. In other words the rental transaction can be completed by the kiosk alone, or the kiosk can handshake with a third party credential system such that the rental transaction is approved and handled by the third-party credential system, which then provides the kiosk an indication that the particular user can go ahead with the securable enclosure rental to the particular user.

In various embodiments, the GUI on the kiosk can be configured to present customer incentives to a user or potential user of the electronic locker system. For example, the GUI may indicate to the user who is in the process of renting one securable enclosure, that if multiple securable enclosures are rented simultaneously, a larger securable enclosure or if the user rents the securable enclosure for a plurality of days, the user will receive additional value in the form of incentive items. Incentive items may be coupons for free food including soft drinks, meals, grocery store purchases, snack bar purchases or dining upgrades at nearby restaurants. Such incentive items may be for goods or services located in or on the property that the securable locker system is located on. For example, the incentive items for goods or services may be located or provided only on the property of the ski resort, health club or recreational center location that the electronic locker system is located on. Alternatively, such incentive items may be provided as services or goods from third-party providers that are not directly associated with the property on which the electronic locker system is located on. Such third party's goods or services may be for goods that can be obtained by the user some distance away from the location of the electronic locker system. The incentives are not for a discount on use of or rental of the electronic locker system. Instead, the incentives are for goods and services that are not associated with rental of a securable locker enclosure. By presenting such incentives to a user while they are in the process of renting a securable enclosure, the user may be incentivized to rent a larger securable enclosure, more securable enclosures or increase the amount of time that the securable enclosure will be rented at the initial time of rental thereby increasing the revenue received by the electronic locker system by offering incentives from third party businesses that may have paid the owner/operator of the locker system a fee to have the incentive offered on the electronic locker system.

In additional embodiments, the user interface may also provide icons or instructions that enable the user of the kiosk to buy or rent other items or services on the property on which the exemplary electronic locker system is located. A user may also be given the opportunity to purchase or rent goods or services from an off property vendor or service provider via the kiosk user interface without having to purchase a longer rental time period, additional securable enclosures. As the owner or operator of an exemplary electronic locker system creates and establishes relationships with other good and service providers both located on the property associated with the exemplary electronic locker system and off property from the location of the exemplary electronic locker system, such goods and service providers may want to advertise or provide a user an opportunity to purchase such goods and services via the electronic locker system GUI while the user is renting a securable enclosure.

This method may enable the owner or operator of the exemplary electronic locker system to obtain revenue from the rental of the individual securable enclosures, as well as additional revenue from enabling sales and services of third-party goods and service providers, such as a jewelry store, rental location, scuba school, ski training, equipment repair service, restaurant owner, car rental or insurance company to advertise or sell their goods and services via the kiosk GUI.

Various locker system embodiments may also provide an indication to a user via the GUI that certain securable locker rentals can be obtained at a discounted price. For example, if the locker is rented for one hour the price may be X dollars. Alternatively, if the same locker is rented for four hours the price is fraction of the one hour rental price, such as 0.5 X per hour or 2X dollars for the 4 hours. A similar discount can be offered via the GUI to a user who rents multiple small lockers instead of one large locker when the kiosk computer system indicates that there is an abundance of small lockers compared to large lockers. Conversely, a discount can be offered via the GUI to a user who rents a larger locker then originally requested on the GUI when the kiosk computer system indicates that there is an abundance of larger lockers as compared to smaller lockers presently available in the locker system.

In various embodiments of the electronic locker system, the kiosk via the GUI and software is configured to enable a user to rent a plurality of securable enclosures simultaneously wherein each of the securable enclosures, regardless of the size of the securable enclosure, is associated with a same PIN. This feature of an exemplary electronic locker system enables an entire family, of for example five individuals on a ski trip at a ski resort, to rent multiple storage lockers without having to remember multiple PIN numbers. When the user interacts with the GUI, one of the inquiries in the GUI is something like, “How many lockers would you like to rent?” Additionally, the GUI may inquire what size or combination of large, medium and small lockers the user would like to rent; or inquire whether the user would like the location of the locker to be near the top, the middle, or the bottom of a locker column as well as the amount of time each locker is to be rented for. Thus, and exemplary electronic locker system can accommodate the actual needs of a group or family of users in a single transaction at the kiosk. This is advantageous and much less time-consuming for the user or users than having the system require that each member of the family or each member of a group interact with the kiosk to set up rental of a securable enclosure for each member of the party separately.

In various embodiments, the GUI can be configured to inquire whether the user would like the individual lockers, of a plurality of rented lockers, to be located in the locker system near each other or randomly located in the same locker array. In some embodiments where there are less than about 100 lockers in the system, a graphic of the locker system can be provided to the user with an indication of all the available lockers in the system. The user upon viewing the graphic of a mapping of all the available lockers in the system may use the GUI touchscreen to select the particular location or locations of the particular lockers that they would like to rent and have all of the rented securable enclosures have a same PIN. This method and system for renting electronic lockers is a much-needed improvement over pre-existing locker systems because it empowers a user to have control over many more variables associated with renting one or more securable enclosures or lockers all the while taking less time at a kiosk to rent a plurality of lockers. If less time is spent a kiosk renting lockers, the line of people in line waiting at the kiosk or kiosks can be minimized during heavy traffic times.

Embodiments of an electronic locker system can be configured to enable a user to obtain a seasonal pass or seasonal locker rental. For example, a skier who is a regular at a ski resort may want to be able to have access to a locker system whenever they go skiing without requiring a payment transaction each time a securable enclosure is needed. The user may be able to obtain a seasonal locker pass at a discounted price when compared to individual daily rentals of a locker. The user may have access to the same locker every time they visit the ski resort or in other embodiments the user may be able to go to a kiosk and pick the location of the locker that the user would like to use based on where on the property they will be on that particular visit or day. A variation of this may be the user who is, for example, a member of a fitness club can pay an additional fee to use a specific or unspecified locker whenever they visit the fitness club during the course of their membership with the fitness club.

In previous electronic locker systems, the text and graphics of a GUI is preprogrammed by the manufacturer of the system upon the electronic locker installation and setup. In such previous systems, changing or updating the text and/or graphics of the GUI required a rewrite or update of the software within the electronic locker kiosk system. The old software needed to be erased and the new and improved software needed to be uploaded and tested on the system. This process often requires an extended downtime or an extended wait for the reprogramming of a locker system to be completed. The reprogramming may be requested by the electronic locker system's owner/operator, but the process of reprogramming the system was out of the control of the owner and operator of the locker system.

Conversely, in embodiments of the electronic locker system, the owner or operator of the system can utilize dynamic text functionality in the GUI. Dynamic text functionality enables the text and graphics within the GUI to be dynamically changed, reprogrammed and displayed or not displayed by the owner operator. Thus, using the database within the kiosk, wording labels for selectable buttons or entries in the GUI can be relabeled by the owner/operator. For example, if the locker system only provides a single size securable enclosure for rent, then there only needs to be one button labeled for the size of the locker to be rented in the GUI. Alternatively, if the owner operator reconfigures the locker arrays to include additional columns of lockers that have small medium and/or large sized securable enclosures, then additional buttons in the GUI will need to be provided with additional labels in the GUI so that a user can select a small, medium or large locker size securable enclosure during the rental process. This type of change can be made by the owner/operator using the dynamic text functionality within the software and database associated with the GUI in embodiments of the present invention. The owner/operator need not request the manufacturer or programmer of the electronic locker system to reprogram the electronic locker system to accommodate the addition of varying sized lockers in the locker array. In some embodiments, the dynamic text functionality is provided via a SQL data table within the GUI database stored within the memory of the processor in the kiosk.

If a locker system is used in a multilingual environment, the owner operator can further use the dynamic text functionality and first create copies of all the GUI pages. Then, using the dynamic text functionality, the owner operator of the locker system can re-label and reword each of the GUI pages to accommodate the various international languages without requiring the system software to be reprogrammed by the manufacturer or the software writer.

In other embodiments of the electronic locker system, the owner operator of the locker system is able to select within the controls of the GUI whether the PIN will have a fixed or static length of, for example, 4 characters or some other fixed length; or have a dynamic PIN length of from 2 to 16 characters long as selected or defined by the user when in the process of renting a securable enclosure. When selecting a dynamic PIN length, the owner operator is enabling the user to choose or define their own PIN that is comprised of a number or characters that may be easily remembered by the user. For example, with dynamic PIN length selection a user can use their house number, area code, phone number, ZIP Code, driver's license number, any number that is comfortable and easy for them to remember as the PIN. Additionally use of a dynamic PIN length provides additional security from a person trying to break into or guess the PIN of a rented securable enclosure. For example, if a static length of 3 numbers is used for every PIN, then there only 1000 different combinations of PIN numbers for each rented securable enclosure and the probability for guessing a three digit PIN for any of the rented securable enclosures is much higher than the probability for guessing a dynamic length PIN of 2 to 16 digits as selected N defined by a user. Additionally, the user experience of using the locker system is enhanced by being able to define a PIN of dynamic length because the user is less likely to forget his selected PIN since it can be any number that is comfortable and easy for the user to remember rather a forced number length that may have no additional meaning to the user. That is, even if the PIN is printed on a receipt provided by the kiosk, the dynamic length PIN is less likely to be forgotten by the user even if the printed receipt is lost because each individual user can select a PIN that is readily memorable to him or her.

In some embodiments, when a user enters the dynamic length PIN into the GUI, the user is not required to indicate how long their PIN is going to be prior to entering it. Instead, the user merely enters the PIN of whatever length it is. When the user is finished entering the PIN, the user merely presses an enter button or its equivalent on the GUI so that the PIN is stored in the database and associated with the user and the securable enclosure or enclosures that the user rented.

Another aspect of an embodiment provides custom reporting from the kiosk for the owner operator of the electronic locker system. Each master kiosk in an exemplary locker system can be configured to provide a complete data download of all activities associated with the electronic locker system over a predetermined amount of time. The download can be provided via the Internet connection or wireless communication system of the kiosk to a cloud-based memory location or specified IP address or database location. The types of data include, but is not limited to, time stamping of securable locker doors opening and closing, the time that each securable enclosure is accessed, how many times each securable enclosure was accessed during a rental period, the duration of each rental, the location of the most frequently rented securable enclosure through the location of the least frequently rented securable enclosure, number of failed attempts to open each securable enclosure, style of payment for each rental and the amount of time a securable enclosure is out of order.

Using the historic information collected, custom reports can be created for the owner operator of embodiments of the electronic locker system. The custom report can created by the computer system within the kiosk to provide the number of rentals per hour by size of enclosure, location of enclosure in the locker array or location of the in a locker column (height of an enclosure); the number of rentals paid for by credit card, cash or other payment method; the average length of a rental by size and location; occupancy reports providing the percent of locker occupancy versus the time of day or week of the year; a comparison of a first array of locker usage with a second array of locker usage based on location on the property; use of offered incentives on the GUI; purchases of non-locker system related items via the GUI; system outages, keypad outage, lock outage and other failure data.

Providing such statistical reporting of locker usage to an owner/operator can provide the owner operator insight into what size lockers are used the most, what geographical location on the property may require additional columns of lockers or fewer columns of lockers, when incentives or discounts should be provided to increase the rental of lockers, and what the income is from the lockers during low occupancy time periods, which lockers may be in need of repair or will probably need to be repaired soon.

Additionally, the information collected can be used by the database and related software within the kiosk or related computers to provide analytic suggestions based on trending patterns, logistic patterns of usage and related data. The analytic suggestions may include suggesting a locker rental price variation based on the demand for lockers rental during a particular week of the year, time of day or season. For example, the rental price for a securable enclosure can be appropriately varied between a maximum rental price and a minimum rental price based on the supply and demand of the available securable enclosures during certain time periods. The rental price can be set higher during statistically proven weeks of known high locker system occupancy and lowered during slower or lower occupancy weeks. Analytics could be used to provide an analysis of whether too many lockers or too few lockers are located on the property or whether more a particular locker array location should have more or less locker columns added based on overall yearly maximum and minimum occupancy and usage.

Suggestions made by the locker system itself could be made to indicate a probability as to how many locker columns comprising lockers of certain sizes should be added or removed from locker arrays located throughout the property. Such analytics are ultimately used to help the owner/operator of the exemplary electronic locker system to maximize their rental profits of securable enclosures based on proven statistical techniques rather than guesswork. The analytics further enable an owner/operator to enhance the experience of a customer on the property. Alternatively, the analytics of the collected data can provide locker system calculated and analyzed feedback to the owner operator to indicate that, for example, last month the overall profit of the electronic locker system could have been increased by a certain amount of dollars if the electronic locker system had been configured to have a certain number of each different size locker located at each different locker array location. Such information is intended to help enable an owner operator to maximize or make better use of space as well as their investment in the electronic locker system so that their profit from the system can be maximized while enhancing the property guest experience.

Referring to FIG. 4, some embodiments provide an electronic locker system wherein there are multiple kiosks 408, 424, 426. In a system with multiple kiosks, there will be a master kiosk server 408 and at least one redundant or backup kiosk server 424. There may also be one or more slave kiosks 426. The multiple kiosks (the master kiosk 408, the backup kiosk 424 and multiple slave kiosks 426) are each connected and can communicate with one another by a network bus 428. The backup kiosk 424 continuously replicates or copies and then stores the database 436 of master kiosk 408 so that if or when the master kiosk server 432 crashes, a crash flag will no longer be set thereby indicating that the master kiosk 408 has crashed. When the backup kiosk 424 reads the master kiosk's crash flag is not being set, the backup kiosk 424 becomes the new master kiosk in the electronic locker system. Additionally, the backup kiosk 424 may send an alarm in the form of a text message, email, phone call or other electronic communication to a system administrator indicating a need to check the master kiosk. By including a backup kiosk 424 that can operate as the new master kiosk when the master kiosk 408 is not operational, users of the locker system can still be able to access their rented lockers and rent new lockers from the backup kiosk's user interface or other kiosk's user interfaces while the master kiosk 408 is down. The backup kiosk server 424 can be essentially the same as the master kiosk server 408 except for a slight difference in its software wherein the backup kiosk 424 is constantly monitoring the master kiosk's crash flag via the network bus 428. That is, the backup kiosk 428 may comprise a user interface, other communication circuitry, a processor, memory, database software and other control software along with an operation system, a power supply and backup power supply, the PLC controller, interface circuits such as RS-485 circuits, and power/data line modems.

In various embodiments there is no backup kiosk, but instead there is a backup server device, which is not designed to interface with a locker user thus it does not have a graphic user interface and related graphic user interface software or APIs.

Any type of kiosk in the system can be used to buy user rent or extend a rental period for any securable enclosure in the first locker array 410 to the Nth locker array 460. Additionally, a user may not not be able to discriminate between kiosks to determine which kiosk is a master or non-master kiosk. From a user's perspective each kiosk operates and provides services identically.

The master kiosk processor 432, via software stored in the memory 434, this also configurable to provide administrative messaging to an administrator of the electronic locker system. Administrative messaging is different from administrative reporting in that administrative messaging is provided only when predetermined events occur. Conversely, administrative reporting provides endless system related data and information about many aspects and functions that occur over time in the electronic locker system.

An administrative message is provided by a text, email, phone message, beeper, wireless communication or other specific Internet application to the owner-operator if there is a nonworking securable enclosure keypad circuit, malfunctioning locker column, power outage, kiosk server crash, request from a user at a kiosk who cannot access their rented securable locker or has another problem with the operation of the system, if all the securable enclosures are sold out or a predetermined percentage of securable enclosures are sold out, or if a predetermined size locker (large, medium, small) has sold out or a predetermined percent of such securable enclosures have sold out. Administrative messaging may also be provided by the system when an important malfunction or event is occurring in an exemplary electronic locker system that may require human administrative intervention. In some embodiments, the owner operator can select, from a predetermined list of possible administrative events, the specific events trigger sending and administrative message to the administrator and the communication method that the kiosk should use to send the administrative message.

Along with administrative messages, some embodiments provide redundant reporting communications to the system administrator. That is, if an administrative message and/or an administrative report is normally provided over a hard wired Internet connection, a secondary or redundant system for sending an administrative message and/or for providing administrative reporting is also configured. The redundant reporting may be performed via a wireless network, radio frequency, infrared, line of sight communication (for use at ski resorts or other locations when there may be a lack of wireless networks available), microwave frequency and or satellite dish communications. Each of these redundant systems could be included as part of the electronics within the master and or backup kiosks. Any of the various communication technology options can be configured and used as the primary or redundant reporting communication systems in an exemplary kiosk or electronic locker system.

Referring again to FIG. 4, the first locker array is comprised of a plurality of locker columns 414-420. The locker columns are configurable to be positioned one locker column next to the other locker column forming the locker array of L locker columns 420. If there is a failure within one locker column, of the plurality of L locker columns, the failed locker column can be easily removed and replaced in a manner that will minimally affect the usage of the other locker columns in the locker array. As discussed previously, None of the individual locker columns of this embodiment require a power connection to a wall socket or other power source other than the power/data line 412 originating from the power data line modem block 446 within a kiosk. Thus to remove, replace, or add a locker column, usually the only wiring that requires connecting or disconnecting is one or two power/data line cables between locker columns

An embodiment of a method for removing an exemplary locker column from an array of locker columns includes
1. Powering down the power data line modem 446 at the kiosk 408.
2. Disconnecting the power/data line 412 from the input and output side of the junction circuit 452 or junction/repeater circuit 454 of the locker column that is being removed.
3. Remove the faulty column of lockers.
4a. Connect a jumper power/data line 412 between the two locker columns that were adjacent to the faulty locker column that was removed.
4b. If the faulty locker column, which was removed, had a junction/repeater circuit 454 then insert and connect a repeater circuit between the two adjacent lockers.
5. Power up the power/data line modem 446.

At this point the first array of lockers 410 will function properly with the missing faulty column of lockers removed. If the faulty column of lockers can be prepared easily, repair can take place at this time.

If a column of lockers (e.g. column the faulty column of lockers or a column of lockers with small enclosures is to be replaced with a column of lockers with, for example, larger enclosures) is to be replaced by another column of lockers, then the following is to be performed:

Perform 1, 2, and 3 above.
4. Insert the replacement column and of lockers in place of the removed column of lockers. If the remove column of lockers had a junction/repeater circuit 454 as part of the junction circuit 452, make sure the replacement column of lockers also has a junction/repeater circuit 454 installed thereon.
5. Connect power/data lines 412 from the adjacent columns of lockers to the input and output ports of the junction circuit 452 (or junction/repeater circuit 454) in the replacement locker column.
6. Power up the power/data line modem 446.
7. Initialize each of the keypads PCB circuits 404, 500 of the securable enclosures in the replacement column of lockers.

The replacement column of lockers is now ready to operate.

If an additional locker column is to be added to an existing locker array, the process is very simple.
1. Physically install the new or additional locker column in its position in the locker array.
2. Connect a power/data line 412 from an adjacent locker output to an input of the junction circuit 452 in the additional locker column. If the additional locker column is a multiple of the predetermined number M of locker columns within a junction/repeater circuit 454 should be installed in the additional locker column.

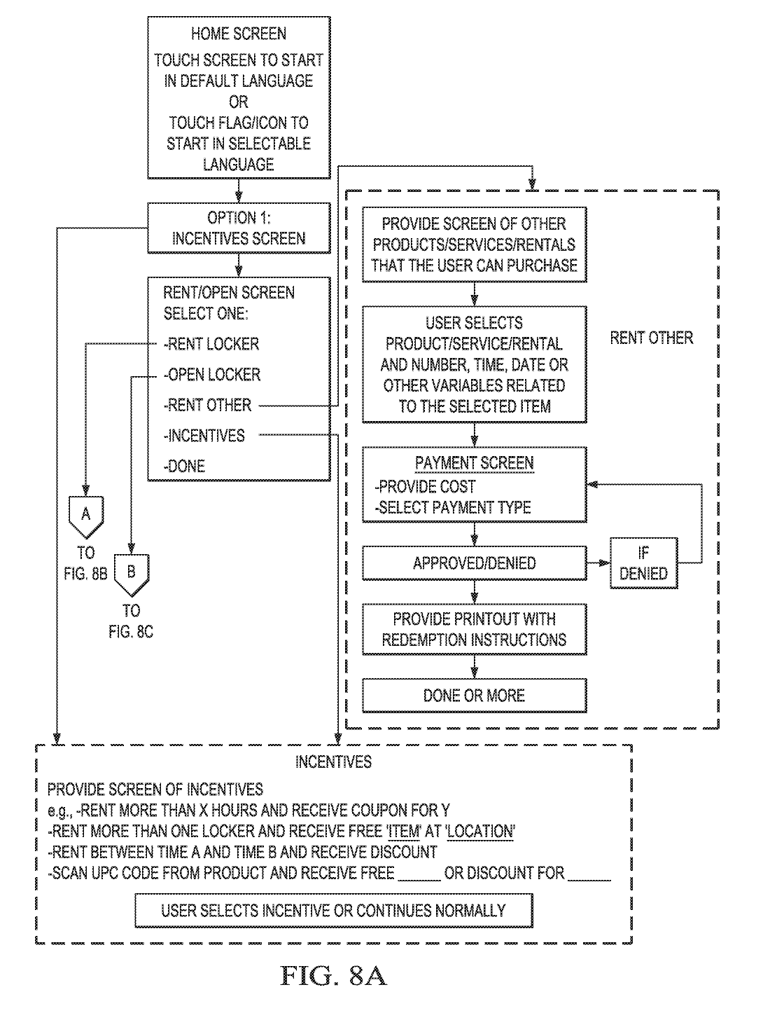

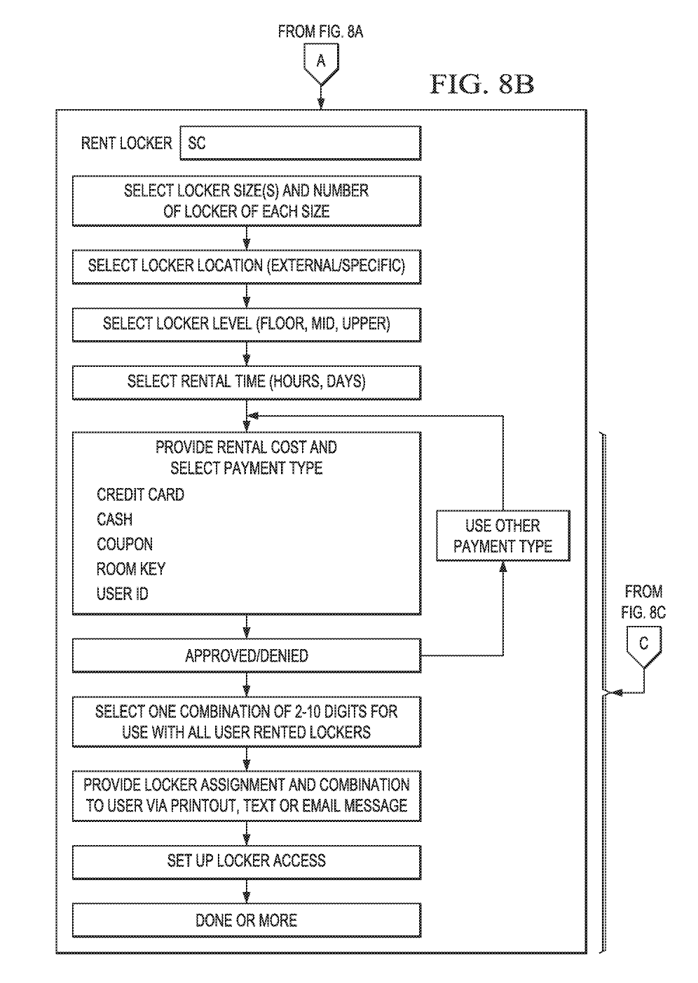

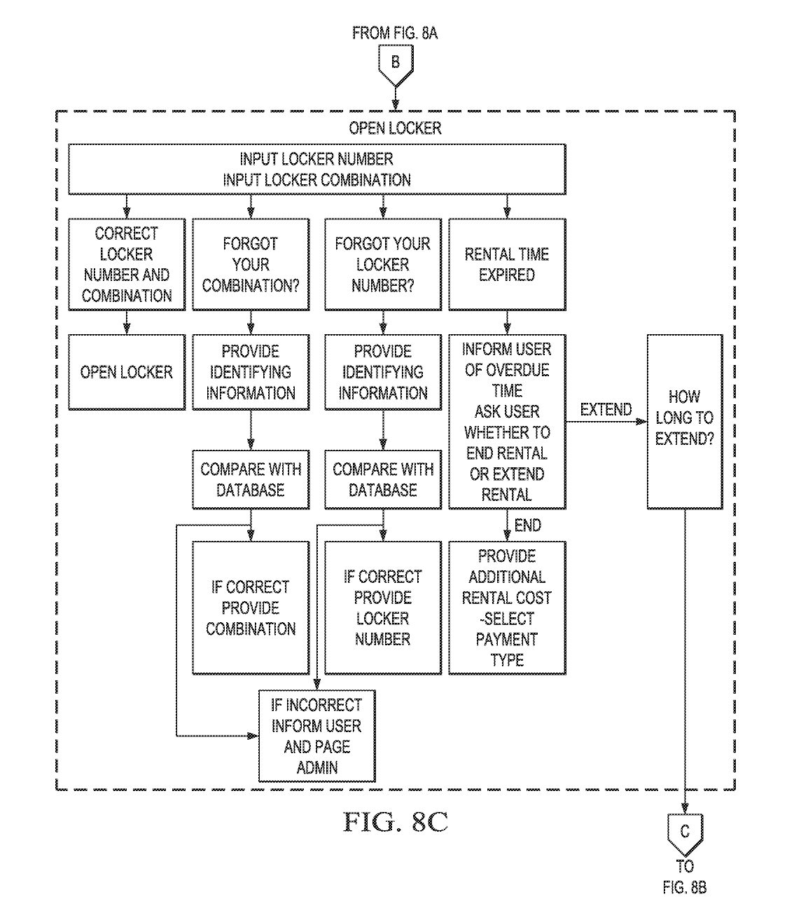

FIGS. 8A, 8B and 8C provide a kiosk user interface flowchart depicting steps a user may proceed through at a kiosk GUI when initiating a securable enclosure rental or to open a securable enclosure after the rental time has expired or when the user forgot his PIN or locker number.

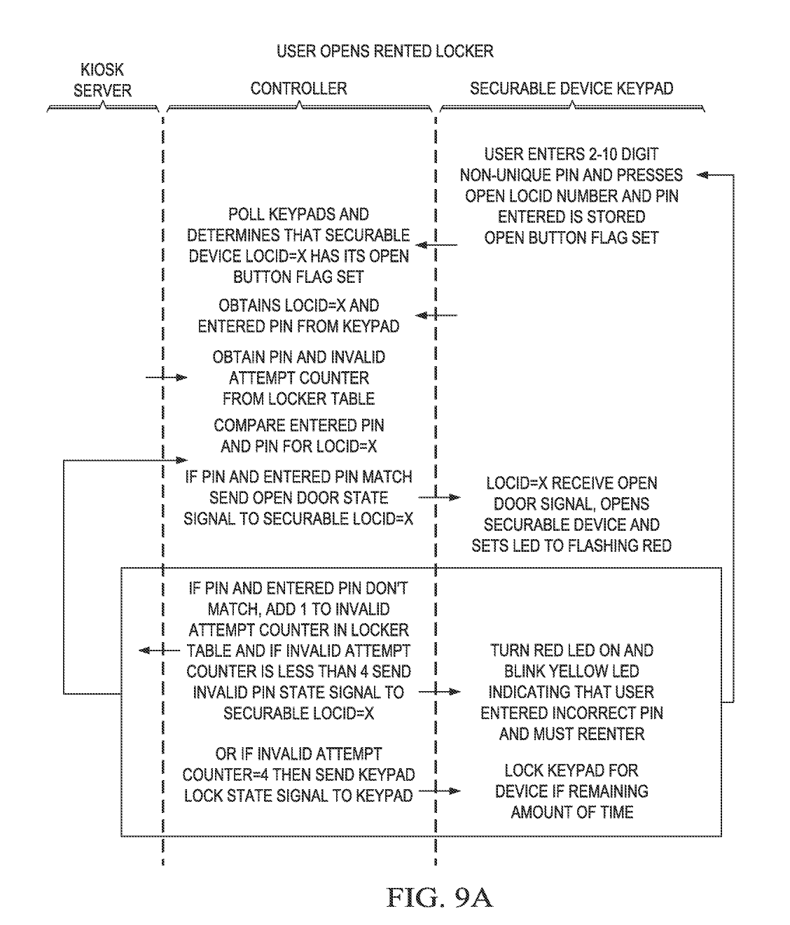

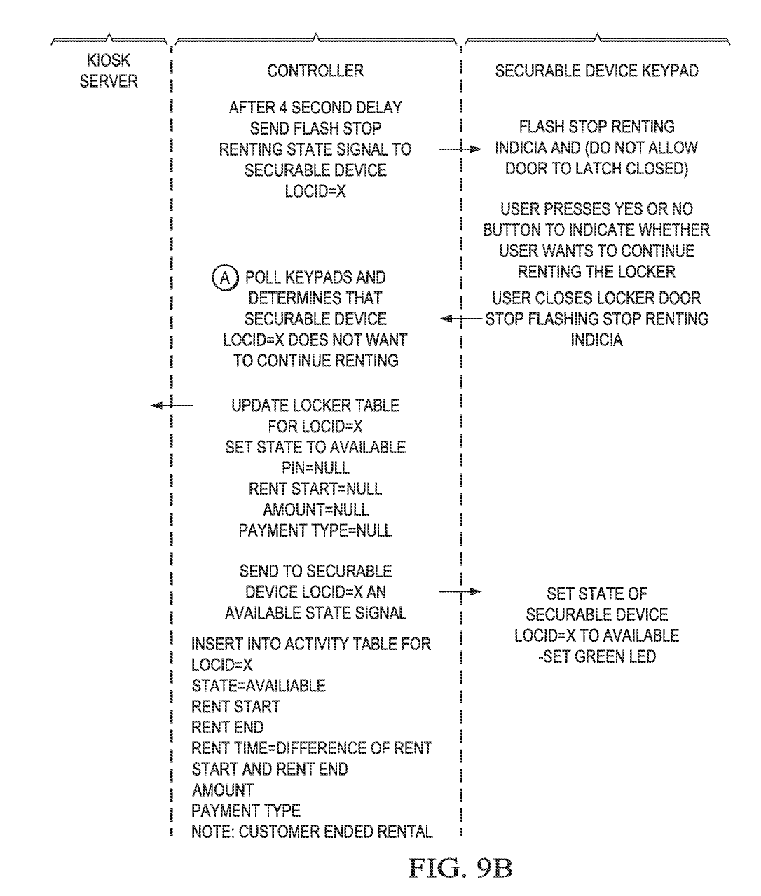

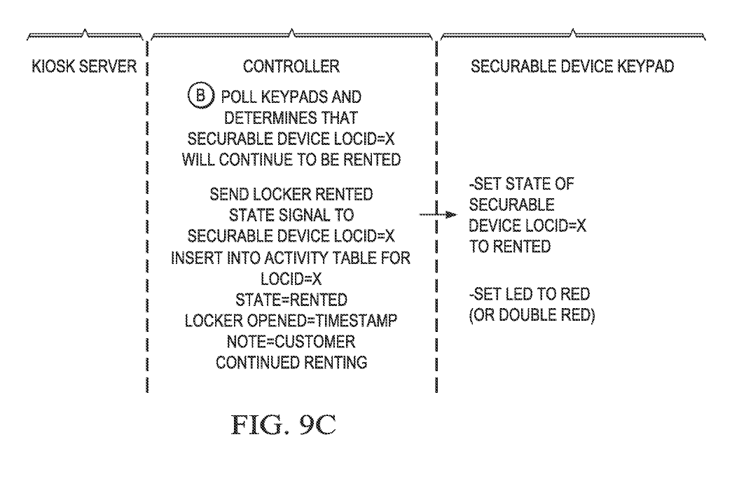

FIGS. 9A through 9C provides various functions of a kiosk server, the PLC and the keypad PCB circuitry as well as the electronic data and interactions there between that are performed when a user opens a rented locker.

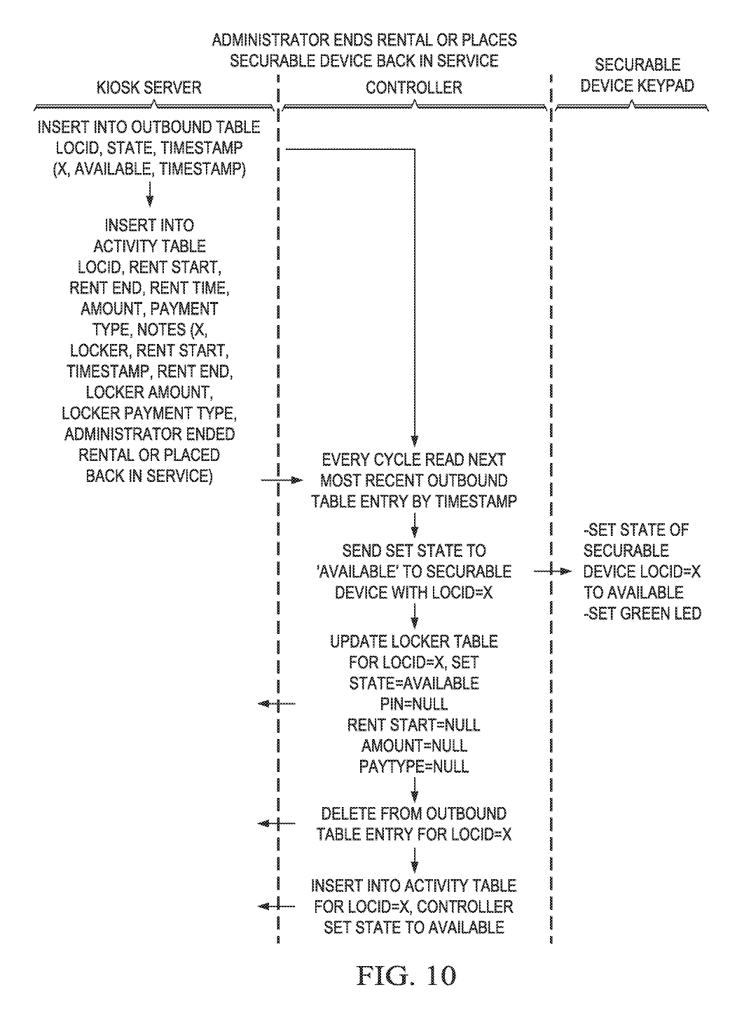

FIG. 10 provides the functions of the kiosk server, the PLC and the keypad circuitry as well as the electronic data interactions there between that are performed when an administrator ends a rental and places a securable enclosure back in into service for rental. An administrator may also selectively remove one or more securable enclosures within a locker array from service.

It is understood that one of ordinary skill in the art will understand that data signals may be represented using any of a variety of different technologies and techniques. For example, data, instructions, commands, information, signals, digital signals, bits, symbols may each represent or be represented by voltages, currents, electromagnetic waves, magnetic fields, optical fields, or any combination thereof.

Various ones of the blocks and algorithm steps described herein may be implemented as hardware, software or a combination of both. Whether such functionality is implemented as hardware or software depends upon the particular application and design constraints imposed on the overall system. The described functionality may be implemented in various ways for each particular application, but such implementation decisions should not be interpreted as causing a departure from the scope of the present invention.

Various illustrative logical blocks, modules, circuits, processors and modems describing connection with the embodiments discussed herein can be implemented or performed by a general-purpose processor based circuit, a digital signal processor (DSP), and application-specific integrated circuit (ASIC), a field programmable gate array (FPGA) or other programmable logic device, discrete gate or transistor logic, discrete hardware components, or any combination thereof designed to perform the functions described herein.

Methods described in connection with the embodiments disclosed herein may be embodied directly as hardware, as a software module stored in memory with instructions executed by a processor, or any combination thereof. A software module or software file can reside in any form of a storage medium known in the art, including, without limitation RAM, ROM, CD-ROM, flash memory, magnetic memory or a removable optical or magnetic disk.

The description provided herein is intended to enable one of ordinary skill in the art to make or use embodiments incorporating the present invention. It may be readily apparent that various modifications can be made to the embodiments without departing from the scope of the invention. Thus, the invention is not intended to be limited to the embodiments shown or described herein, but is accorded the widest scope consistent with the principles and novel features disclosed herein.

1. An electronic filing system comprising:
a plurality of columns of lockers wherein each column of lockers comprises:
a plurality of securable enclosures wherein each securable enclosure comprises a keypad circuit and an electromechanical locking mechanism electrically connected to the keypad circuit; and
a junction circuit configured to connect power and data to each one of the plurality of securable enclosures in the column of lockers; and
a kiosk comprising:
a user interface configured for a user to receive and enter information relative to renting a securable enclosure from among all the columns of lockers;
a memory device comprising a non-transitory computer readable medium for storing one or more computer programs and at least one database configured to track securable enclosure status;
a processor configured to interact with the user interface, the memory device and the database in order to control and track the rental and status of each securable enclosure; and
digital I/O circuitry configured to provide both a data interface between the processor and each securable enclosure's keypad circuit and electromechanical locking mechanism and to provide all the necessary power to each of the plurality of columns of lockers;
wherein the processor is configured to enable a single user to rent a plurality of securable enclosures located in different columns of lockers and to use a same user defined personal identification number (PIN) as an input PIN at each one of the plurality of securable enclosure's keypad circuits via a single user transaction at the user interface of the kiosk.
